(19) United States
(12) Patent Application Publication
(10) Pub. No.: US 2010/0255272 A1
(43) Pub. Date: Oct. 7, 2010

(54) ATTACHED FILM

(75) Inventor: CHUN-YUAN CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/755,441

(22) Filed: Apr. 7, 2010

(30) Foreign Application Priority Data
Apr. 7, 2009 (CN) 200910301390.5

(51) Int. Cl. B32B 3/10; B32B 5/00

(52) U.S. Cl. 428/201; 428/335; 428/336

(57) ABSTRACT

An attached film for in-mold-decoration is provided for attaching an outer surface of a molded product. The attached film includes a base layer, an attaching layer attached to a first side of the base layer, and a hard-coating layer attached to a second side of the base layer. The thickness of the hard-coating layer ranges from 0.0005 millimeters to about 0.035 millimeters.

### TECHNICAL FIELD

The disclosure relates to attached films, and particular to an attached film for in-mold-decoration (IMD).

### DESCRIPTION OF RELATED ART

A common method for IMD is covering a molded product with an attached film to decorate and protect the molded product. The attached film usually includes a carrier layer, a peeling layer, a protecting layer, and an attaching layer attached to the base of the molded product. While the carrier layer and the peeling layer are released from the molded product, the protecting layer helps protect the attaching layer and the base from scratches. Nevertheless, the protecting layer always seems to be damaged.

### BRIEF DESCRIPTION OF THE DRAWINGS

FIG. 1 is a cross-sectional view of a first embodiment of an attached film.

FIG. 2 is a cross-sectional view of a second embodiment of an attached film.

### DETAILED DESCRIPTION

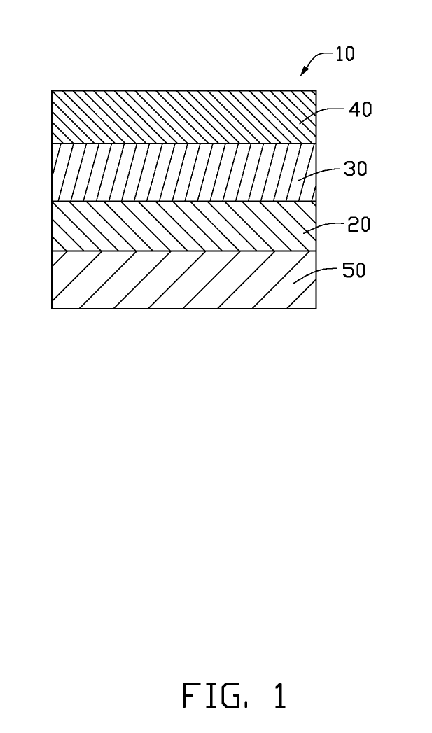

Referring to FIG. 1, a first exemplary embodiment of an attached film 10 for in-mold-decoration includes an attaching layer 20, a base layer 30, and a hard-coating layer 40.

The attaching layer 20 attaches the attached film 10 to a base 50 of a plastic article made by injecting mold. The attaching layer 20 may be made from at least one of a plurality of resin materials including acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin, for example. The attaching layer 20 is generally provided via gravure printing, screen printing, offset printing, spraying, or dip-coating, for example.

The base layer 30 is attached to the attaching layer 20 opposite to the base 50 and generally consists of at least one of polycarbonate, polyethylene terephthalate, acrylic, oriented polypropylene, or polyvinyl chloride, for example. The thickness of the base layer 30 can range from about 0.01 millimeters to about 0.125 millimeters.

The hard-coating layer 40 is attached to the base layer 30 opposite to the attaching layer 20. The hard-coating layer 40 functions as a scratch/abrasion-resistant layer for the base layer 30, the attaching layer 20, and the base 50. The thickness of the hard-coating layer 40 can range from about 0.0005 millimeters to about 0.035 millimeters. The hard-coating layer 40 is made of thermosetting resin, or resin curable with ionizing radiation selected from the group consisting of ultraviolet rays and electron beams.

Ultraviolet curable resin includes ultraviolet curable acrylic urethane resin, ultraviolet curable polyester acrylate resin, or ultraviolet curable epoxy acrylate resin. Ultraviolet curable resin can be used with a photoinitiator. For example, ultraviolet curable acrylic urethane resin is obtained by reaction of polyester polyol with isocyanate monomer or prepolymer and by reaction of a resultant product with acrylate or methacrylate monomer having hydroxyl groups. As the photoinitiator may be used with benzophenones, acetophenones, or anthraquinone derivatives, singly or in a combination thereof. For improved formation of the coating, the thermoplastic acrylic resin may be selected and blended with ultraviolet curable resin.

Methods of manufacturing the hard-coating layer 40 includes coating selected from the group consisting of gravure coating, roll coating, comma coating, and a printing process selected from the group consisting of gravure printing and screen printing.

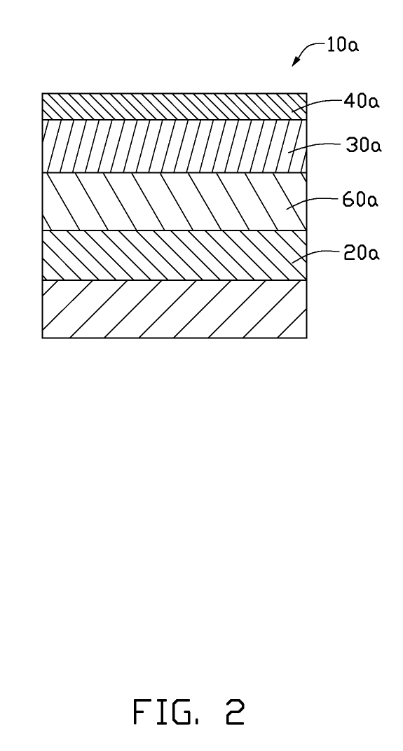

Referring to FIG. 2, a second exemplary embodiment of an attached film 10a for in-mold-decoration includes an attaching layer 20a, a base layer 30a, a hard-coating layer 40a, and a pattern layer 60a sandwiched between the attaching layer 20a and the base layer 30a.

The pattern layer 60a may be provided by printing ink on the base layer 30a. A metal decorative layer can be provided as the pattern layer 60a. The metal decorative layer may be aluminum, chromium, copper, nickel, indium, or tin, alone or combined, on the base layer 30d via either a vacuum evaporation or electroplating method. The addition of a separate hard layer for protection as well as a decorative pattern layer provides better protection for the base layer, attaching layer, and base.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. An attached film for in-mold-decoration, the attached film comprising:
a base layer;
an attaching layer attached to a first side of the base layer; and
a hard-coating layer attached to a second side of the base layer opposite to the attaching layer, wherein the thickness of the hard-coating layer ranges from 0.0005 millimeters to about 0.035 millimeters.

2. The attached film of claim 1, wherein the attaching layer is made from at least one of a plurality of resin material comprising acrylic, nitrification fiber, polyamine formate, chlorination rubber, vinyl chloride-co-vinyl-acetic ester copolymer, polyamide, polyester, epoxy, polycarbonate, olefin, or acrylonitrile-butylene-styrene monomer resin.

3. The attached film of claim 1, wherein the base layer is made from at least one of polycarbonate, polyethylene terephthalate, acrylic, oriented polypropylene, or polyvinyl chloride.

4. The attached film of claim 1, wherein the hard-coating layer is made of thermosetting resin, or curable resin by ionizing radiation.

5. The attached film of claim 4, wherein the hard-coating layer is made of curable resin by ultraviolet ray or election beam.

6. The attached film of claim 4, wherein the ultraviolet curable resin comprises ultraviolet curable acrylic urethane resin, ultraviolet curable polyester acrylate resin, and ultraviolet curable epoxy acrylate resin, and is used with a photoinitiator.

7. The attached film of claim 6, wherein the photoinitiator may be made of benzophenones, acetophenones, anthraquinone derivatives, singly or in combination.

8. The attached film of claim 1, wherein the attached film further comprises a pattern layer sandwiched between the attaching layer and the base layer, the pattern layer is provided by printing ink on the base layer.

9. The attached film of claim 1, wherein the attached film further comprises a pattern layer sandwiched between the attaching layer and the base layer, a metal decorative layer can be provided as the pattern layer, the metal decorative layer is made of aluminum, chromium, copper, nickel, indium, or tin, alone or combined, on the base layer.

10. An attached film for in-mold-decoration, the attached film comprising:
a base layer;
an attaching layer attached to the base layer;
a pattern layer sandwiched between the attaching layer and a first side of the base layer; and
a hard-coating layer attached to a second side of the base layer opposite to the pattern layer, wherein the thickness of the hard-coating layer ranges from 0.0005 millimeters to about 0.035 millimeters.

11. The attached film of claim 10, wherein the attaching layer is made from a resin material selected from the group consisting of acrylic, nitrification fiber, polyamine formate, chlorination rubber, vinyl chloride-co-vinyl-acetic ester copolymer, polyamide, polyester, epoxy, polycarbonate, olefin, and acrylonitrile-butylene-styrene monomer resin.

12. The attached film of claim 10, wherein the base layer generally comprises at least one of polycarbonate, polyethylene terephthalate, acrylic, oriented polypropylene, or polyvinyl chloride.

13. The attached film of claim 10, wherein the hard-coating layer is made of thermosetting resin or curable resin.

14. The attached film of claim 13, wherein the hard-coating layer is made of curable resin by ultraviolet ray or election beam.

15. The attached film of claim 14, wherein the ultraviolet curable resin comprises ultraviolet curable acrylic urethane resin, ultraviolet curable polyester acrylate resin, and ultraviolet curable epoxy acrylate resin, and is used with a photoinitiator.

16. The attached film of claim 15, wherein the photoinitiator is made of benzophenones, acetophenones, anthraquinone derivatives, alone or combined.

17. The attached film of claim 10, wherein the pattern layer made of ink or metal.

18. The attached film of claim 17, wherein the metal is aluminum, chromium, copper, nickel, indium, tin, alone or combined.
